(19) United States
(12) Patent Application Publication
(10) Pub. No.: US 2002/0073606 A1
(43) Pub. Date: Jun. 20, 2002

(54) Cover for a fishing lure

(76) Inventor: John Mameamskum, Kawawachikamach (CA)

Correspondence Address: Mr. Allison C. Collard, Collard & Roe, P.C., 1077 Northern Boulevard, Roslyn, NY, 11576, US

(21) Appl. No.: 09/739,437

(22) Filed: Dec. 18, 2000

(51) Int. Cl. A01K 85/14

(52) U.S. Cl. 43/42.5

(57) ABSTRACT

A one-piece cover for a fishing lure having a top and bottom face. The cover having a hollow concave body designed to be mounted over the front face of the fishing lure. The cover also comprising a dome-shaped structure to enhance the colors of the lure and to give a hydro and aerodynamic structure to the lure. The cover further comprising securing means allowing same to be mounted on the lure in a snap-fit fashion.

### FIELD OF THE INVENTION

The present invention relates to a cover for a fishing lure.

### BACKGROUND OF THE INVENTION

It is known that repeated use of fishing lure causes it to lose its brilliance and thus its luring properties. To overcome this problem, it has been suggested to provide covers adapted to be fit over fishing lures shaped as a spoon or a blade.

By way of examples, U.S. Pat. No. 3,289,345 (RENINGER et al.) discloses a sleeve having different colour and design and adapted to be slipped on the fishing lure. The sleeve thus gives new life to the old fishing lure.

U.S. Pat. No. 3,392,474 (WEESE et al.) also discloses a cover for a fishing lure. As in the previously mentioned US patent, this cover has a desired colour, design and/or artwork on its external surface in order to give life to the old lure. It is also designed for the purpose of providing, in an inexpensive and simple way, various looks for a same lure.

U.S. Pat. No. 2,796,693 (GUNTHERMAN) discloses a fishing lure assembly having interchangeable inserts detachably connectable to a body portion. The lure is provided with a body portion formed of a thin, non-resilient metal having at least one face, which is highly polished to provide a reflective face. The lure assembly of this patent has relatively flattened side areas. Furthermore, the interchangeable insert is suitably coloured and usable with the body portion.

U.S. Pat. Nos. 2,510,566, 3,389,344, 3,540,144, 4,870,776 and 5,333,406 disclose also receptacle covers made of a transparent moulded plastic product.

### SUMMARY OF THE INVENTION

A first object of the present invention is to provide a cover for a fishing lure, that is easy to install and remove therefrom.

A second object of the present invention is to provide a cover for a fishing lure, which enhance the colour and shape of any existing fishing lure.

A third object of the present invention is to provide a fishing lure cover that protects the original colour of the fishing lure.

A fourth object of the invention is to provide a cover for a fishing lure, which has such a structure as to give a magnifying effect of the lure.

A fifth object of the present invention is to provide a cover adapted to fit on at least on side of the lure.

In accordance with the present invention, there is provided a one-piece cover for a fishing lure having a front face and a peripheral edge comprising:

a hollow concave body sized and shaped to substantially cover and surround the front face of the fishing lure;

a dome-shaped structure protruding outwardly from the hollow concave body, said dome-shaped structure acting as a magnifying means for enhancing colours and giving hydro- and aerodynamics of the fishing lure; and

securing means provided on longitudinal facing edges of the hollow concave body for holding the cover snugly fit over the fishing lure.

An advantage of the lure cover of the present invention is that it has a twofold impact on the environment. Indeed, its use will protect and prolong the use and life of different fishing lures, thereby decreasing the need to use lead and other metal devices for the manufacture of new lures.

Another advantage of the lure cover of the present invention is that it has different properties that are normally found in separate fishing accessories. More particularly, the cover provides a magnifying effect that will enhance the original colour(s) of the lure. The cover also has a weight effect thereby replacing the need for lead sinkers, lead jigs and the like which are, toxic pollutants over time, especially if lost in the ecosystems.

Finally, another advantage of the lure cover of the present invention is that it gives a hydro- aerodynamic effect to the lure thanks to its dome-shaped structure.

The present invention and its advantages will be more easily understood after reading the following non-restrictive description of preferred embodiments thereof, made with reference to the hereinbelow drawings.

### BRIEF DESCRIPTION OF THE DRAWINGS

FIG. 1 is a perspective view of a cover for a fishing lure according to a preferred embodiment of the present invention.

FIG. 2 is a top plan view of the cover and fishing lure shown in FIG. 1.

FIG. 3 is a bottom view of the cover and fishing lure shown in FIGS. 1 and 2.

FIG. 4 is a side view of the cover and fishing lure shown in FIGS. 1 to 3.

FIG. 5 is front view of the cover and fishing lure shown in FIGS. 1 to 4.

FIG. 6 is a rear view of the cover and fishing lure shown in FIGS. 1 to 5.

FIG. 7 is a perspective view of the cover according to another preferred embodiment of the present invention.

### DETAILED DESCRIPTION OF THE INVENTION

The cover 1 for a fishing lure 3 according to the preferred embodiment of the invention as shown in the accompanying drawings is intended to be used with a fishing lure 3 having the general shape of an elongated spoon. The fishing lure has a top 5 and bottom 7 face. Preferably, the top face 5 is convex and the bottom face 7 is concave. The fishing lure 3 may be further adapted to allow fastening of a hook or the like thereon.

In the illustrated embodiment, the fishing lure has a front portion 9 that is wider than the back portion 11. This allows the fishing lure to be hydro and aerodynamic in the water. Furthermore, the front portion 9 has an opening 13 for receiving a fastener for fastening the lure to the fishing line. The back portion 11 also has an opening 15 for receiving a fastener for fastening a hook or the like to the lure.

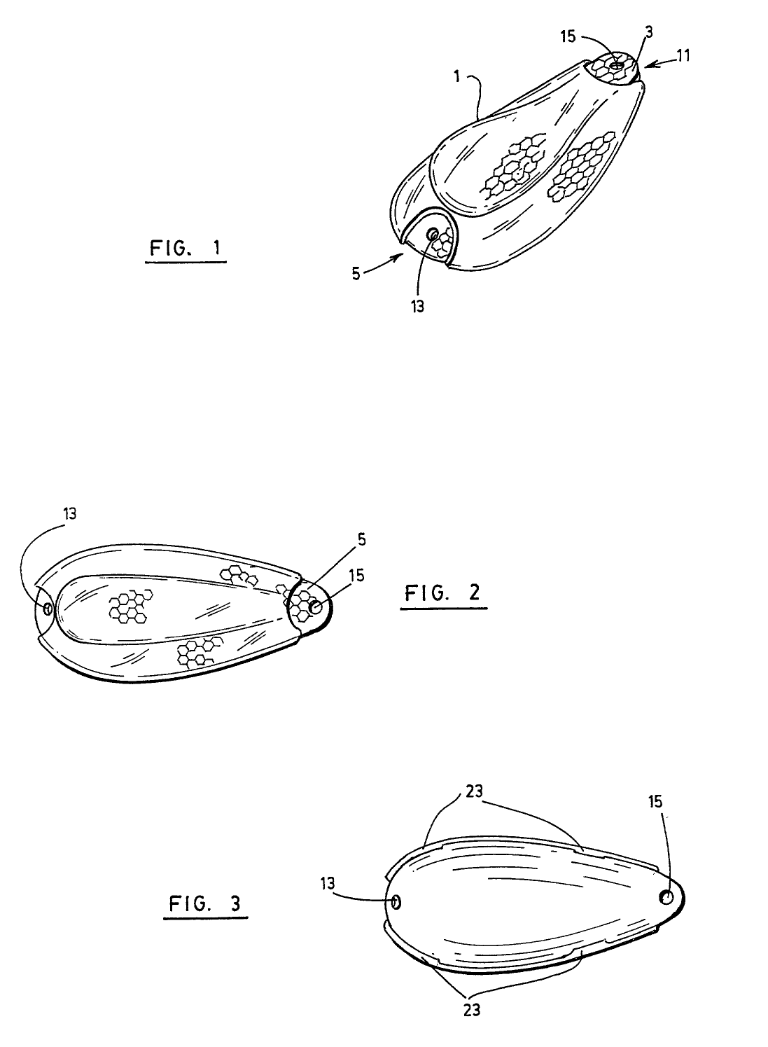

Referring now to FIGS. 1 to 3, the cover 1 of the present invention is adapted to be mounted over the top face 5 of the fishing lure 3. The cover has a hollow concave body sized and shaped to substantially cover and surround the top face of the fishing lure. In the illustrated embodiment, the fishing lure 3 is sized to cover up to 90% the top face of the fishing lure 3.

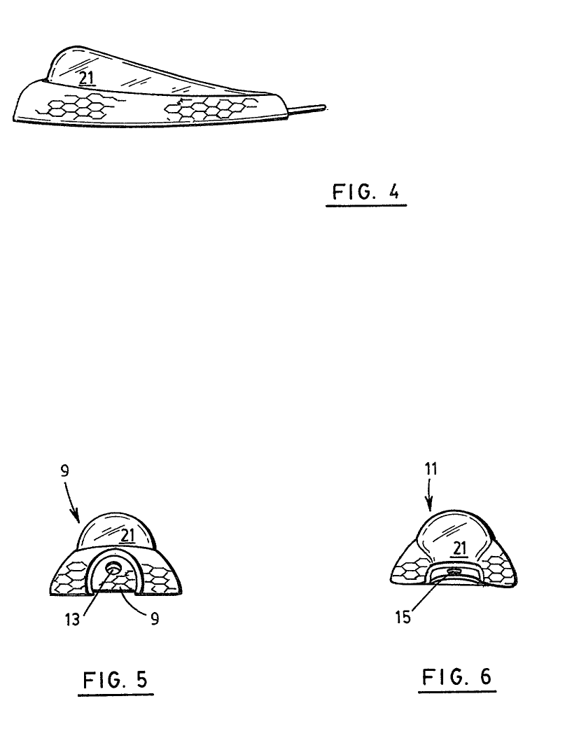

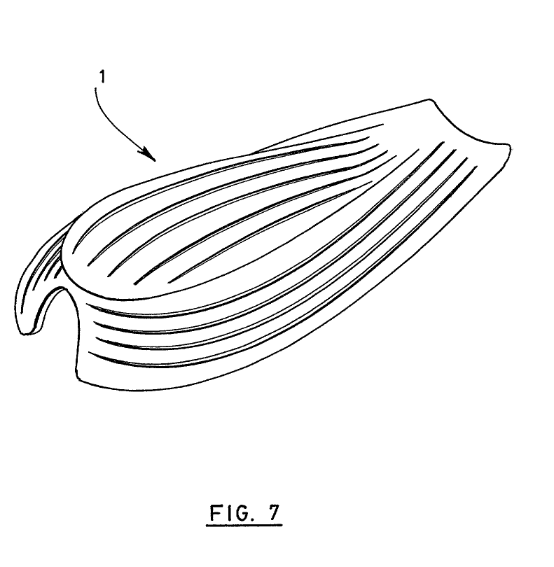

The cover also comprises a dome-shaped structure 21 protruding outwardly from the hollow concave body. As best seen in FIGS. 4 to 6, the dome shaped structure acts as a magnifying means for enhancing the colour of the fishing lure. Securing means are provided on the cover for allowing the cover to be tightly fastened to the fishing spoon lure. As shown in the illustrated embodiment, the securing means are located on longitudinal facing edges of the hollow concave body for holding the cover snugly fit over the fishing lure. The securing means preferably comprises two pairs of grippers 23 designed to grip a portion of the peripheral edge of the fishing lure (see FIG. 3). This allows the cover of the invention to be mounted on the fishing lure in a snap-fit fashion.

FIGS. 4 to 6, also show that the hollow concave body and the dome shaped structure 21 of the cover 1 are smooth and clear. However, it should be understood that the invention is not limited to clear covers and may include opaque covers, covers having a fluorescent colour, or a clear cover having one or a mixture of different colours on the dome-shaped structure and the longitudinal facing edges so to create a completely different colour and look for the spoon lure when the cover is installed thereon.

As shown in FIG. 7, the cover according to a preferred embodiment of the invention may also comprise a series of grooves to enhance its hydro and aerodynamic properties.

The cover 1 of the invention is preferably made of a recyclable moulded plastic material such as a high impact styrene. For the purpose of the present invention, any plastic material that will not prevent the lure from sinking is suitable for the manufacture of the cover of the present invention.

It should be noted that the cover of the present invention may be adapted to fit any size of fishing lure. Preferably, the cover can be sized to surround and cover a fishing lure of any one of the following sizes: half ounce, quarter ounce, one ounce and two ounces.

Although the present invention has been explained hereinabove by way of a preferred embodiment thereof, it should be pointed out that any modifications to this preferred embodiment within the scope of the present invention is not deemed to alter or change the nature and scope of the present invention.

1. A one-piece cover for a fishing lure having a front face and a peripheral edge comprising:
a hollow concave body sized and shaped to substantially cover and surround the front face of the fishing lure;
a dome-shaped structure protruding outwardly from the hollow concave body, said dome-shaped structure acting as a magnifying means for enhancing colours and giving a hydro- and aero-dynamic structure of the fishing lure; and
securing means provided on longitudinal facing edges of the hollow concave body for holding the cover snugly fit over the fishing lure.

2. A one-piece cover according to claim 1, which said cover made of a moulded material that is 100% recyclable.

3. A one-piece cover according to claim 2, wherein the moulded material is a high impact styrene.

4. A one-piece cover according to claim 1, wherein the fishing lure has any one of the following sizes: half ounce, quarter ounce, three quarter ounce, one ounce and two ounces.

5. A one-piece cover according to claim 1, wherein the securing means comprises at least two grippers designed to grip a portion of the peripheral edge of the fishing lure.

6. A one-piece cover according to claim 1, wherein the hollow concave body and the dome-shaped structure are clear and smooth.

7. A one-piece cover according to claim 1, further comprising a series of grooves to enhance hydro and aero dynamic properties of the cover.

8. A one-piece cover according to claim 1, wherein said cover has a fluorescent colour.

9. A one-piece cover according to claim 1, wherein the cover is a clear cover and has one colour or a mixture of different colours thereby creating a new colour of the fishing lure when the cover is installed thereon.

10. A one-piece cover according to claim 1, wherein said cover is sized to cover up to 90% the front face of the fishing lure.
